(19) United States
(12) Patent Application Publication
(10) Pub. No.: US 2005/0200257 A1
(43) Pub. Date: Sep. 15, 2005

(54) Fluorescent lamp with reduced end blackening and mount therefor

(75) Inventors: Steven C. Schlitt, Merrimac, MA (US); Pascal Horion, Drummondville (CA)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/143,856

(22) Filed: Jun. 2, 2005

(51) Int. Cl. H01J 1/00; H01J 17/22; H01J 19/70

(52) U.S. Cl. 313/238; 313/240

(57) ABSTRACT

A fluorescent lamp (10) has an elongated glass envelope (12) with a mount structure (14) sealing each end (16) of the envelope (12). The mount structure (14) comprises a glass base (18) with two spaced apart lead-in wires (20, 22) sealed into the glass base (18) and extending into the envelope (12). An electrode (24) is connected between the lead-in wires (20, 22) within the envelope (12) and an electrode shield (26) surrounds the electrode (24). The electrode shield (26) has an open top (26a) and an open bottom (26b) and a wall (26c) that is substantially equidistantly spaced from the electrode (24). A support member (28) is attached only to the shield wall (26c) and to one of the lead-ins, for example, (22), thereby making the shield (26) electrically active when the lamp is operating.

### TECHNICAL FIELD

This invention relates to fluorescent lamps and more particularly to highly loaded lamps, especially for those used in UV tanning booths.

### BACKGROUND ART

Hot cathode fluorescent lamps are subject to end blackening due to the deposition of sputtered and evaporated compounds from the electrodes depositing upon the cooler ends of the lamp envelope during operation of the lamps. While these deposits do not normally effect the proper functioning of the lamp, nevertheless, in some instances the aesthetic effect of the lamp is impaired.

To prevent or at least reduce the amount of the blackening it has been proposed to shield the electrodes. Shields, both electrically insulated and electrically active have been proposed. See, for example, U.S. Pat. Nos. 4,891,551; 5,004,949; 6,741,023; and 6,809,468. While at least partially effective for their intended purpose, these shields have been cumbersome, expensive and difficult to mount, in some instances requiring an extra support sealed into the glass base (U.S. Pat. Nos. 4,891,551 and 5,004,949) and in other instances requiring a large cup-shaped shield that is difficult to manufacture and that, when installed, casts an objectionable shadow upon the lamp envelope (U.S. Pat. Nos. 6,741,023 and 6,809,468).

### DISCLOSURE OF INVENTION

It is, therefore, an object of the invention to obviate the disadvantages of the prior art.

It is another object of the invention to enhance fluorescent lamps.

It is another object of the invention to enhance fluorescent lamp shielding.

Yet another object of the invention is the provision of a simple and convenient shield that does not require extra support members inserted into the glass base and that is suited to automatable assembly.

These objects are accomplished, in one aspect of the invention, by a fluorescent lamp that includes an elongated glass envelope; a mount structure sealing each end of the envelope, each of the mount structures having a glass base; two spaced apart lead-in wires sealed into the glass base and extending into the envelope; an electrode connected between the lead-in wires within the envelope; and an electrode shield surrounding the electrode, the electrode shield being substantially equidistantly spaced from the electrode; and wherein the improvement comprises a support member attached only to the shield and to one of the lead-ins.

This electrically active shield does not require extra support units sealed into the glass base and delivers more light to the end of the lamp than the cumbersome cup-shaped shields.

### BRIEF DESCRIPTION OF THE DRAWINGS

FIG. 1 is a perspective view of an embodiment of a mount of the invention;

FIG. 2 is an elevational view of a lamp end;

FIG. 3 is a plan view of the shield and electrode; and

FIG. 4 is a graph illustrating the amount of illumination available at the end of the lamp.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

Referring now to the drawings with greater particularity, the is shown in FIG. 2 a fluorescent lamp 10 including an elongated glass envelope 12 with a mount structure 14 sealing each end 16 of the envelope 12.

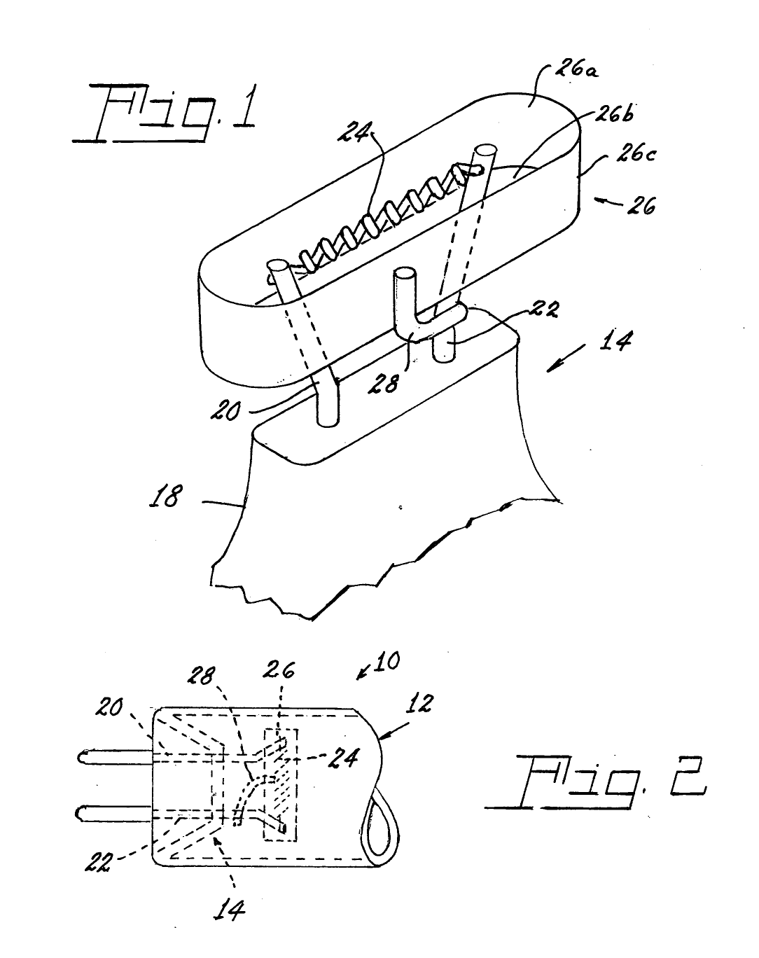

The mount structure 14 is shown enlarged in FIG. 1 and comprises a glass base 18 with two spaced apart lead-in wires 20, 22 sealed into the glass base 18 and extending into the envelope 12. An electrode 24 is connected between the lead-in wires 20, 22 within the envelope 12 and an electrode shield 26 surrounds the electrode 24. The electrode shield 26 has an open top 26a and open bottom 26b and a wall 26c that is substantially equidistantly spaced from the electrode 24. A support member 28 is attached only to the shield wall 26c and to one of the lead-ins, for example, 22, thereby making the shield 26 electrically active when the lamp is operating.

In a preferred embodiment of the invention the shield 26 is constructed from a material having a thickness of from 0.15 mm to 0.25 mm and selected from cold rolled steel, nickel or nickel-plated steel, with nickel-plated steel being preferred, and the support member 28 is selected to have the same properties as the shield, for example, nickel-plated steel wire having a diameter of 0.30 inches (0.823 mm). Preferably, the support member 28 is welded to the shield wall 26c and one of the lead-in wires.

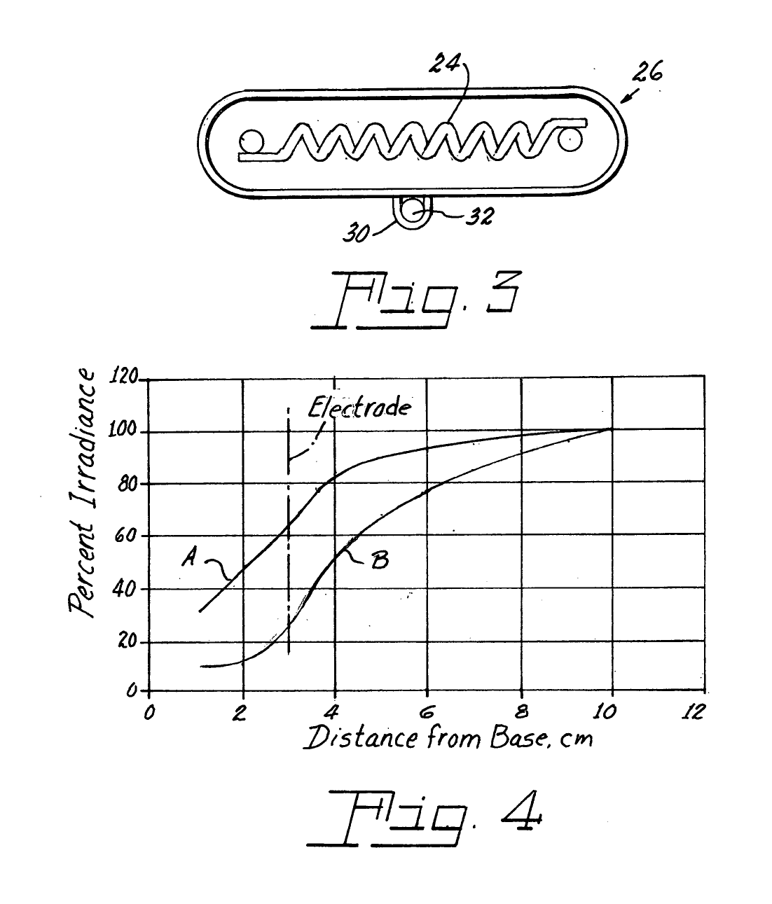

In an alternate form of the invention, the shield wall 26c can be provided with a perforation tab 30, as seen in FIG. 3, and one end 32 of the support member 28 is attached to the tab 30 as by crimping or other suitable method.

The efficacy of the end brightness of the instant invention compared to the end brightness of one of the cup-shaped shields of the prior art is shown by the graph of FIG. 4, wherein line A represents the shield of the invention and line B represents a cup-shaped shield. At the critical distance of 3 cm (the distance of the electrode from the end of the lamp) it will be seen that the shield of the instant invention provides a brightness level 2.3 times greater than the cup-shaped shield.

And, of course, relative to the similar shields of the prior art, this invention adds simplicity, the convenience of automation capabilities, and the elimination of the sealed-in support member, which latter provision strengthens the glass seal and eliminates a potential leakage site.

While there have been shown and described what are present considered to be the preferred embodiments of the invention, it will be apparent to those skilled in the art that various changes and modifications can be made herein without departing from the scope of the invention as defined by the appended claims.

1. A fluorescent lamp including:
an elongated glass envelope;
a mount structure sealing each end of said envelope, each of said mount structures having:
a glass base;
two spaced apart lead-in wires sealed into said glass base and extending into said envelope;
an electrode connected between said lead-in wires within said envelope; and
an electrode shield surrounding said electrode, said electrode shield being substantially equidistantly spaced from said electrode;
the improvement comprising a support member attached only to said shield and to one of said lead-ins.

2. The fluorescent lamp of claim 1 wherein said shield is constructed from a material selected from cold rolled steel, nickel and nickel-plated steel.

3. The fluorescent lamp of claim 2 wherein said support member is constructed from a wire material selected from cold rolled steel, nickel and nickel-plated steel.

4. The fluorescent lamp of claim 1 wherein said shield includes a formed tab and said support member is attached to said tab.
